(19) United States
(12) Patent Application Publication
(10) Pub. No.: US 2013/0147248 A1
(43) Pub. Date: Jun. 13, 2013

(54) VEHICLE SEAT AND MANUFACTURING METHOD

(71) Applicant: GM Global Technology Operations LLC, Detroit, MI (US)

(72) Inventors: Eduard WOLF, Pfungstadt (DE); Michael Hoefgen-Allmann, Riedstadt (DE)

(73) Assignee: GM GLOBAL TECHNOLOGY OPERATIONS LLC, Detroit, MI (US)

(21) Appl. No.: 13/708,752

(22) Filed: Dec. 7, 2012

(30) Foreign Application Priority Data
Dec. 8, 2011 (DE) 102011120533.4

(51) Int. Cl. B60N 2/12

(52) U.S. Cl. CPC B60N 2/12
USPC 297/325; 29/428

(57) ABSTRACT

A vehicle seat for a vehicle that comprises a seat structure and at least one seat rail arrangement is provided. At least one adapter device is provided between the seat structure and the at least one seat rail arrangement in order to ensure a sliding motion and/or pivoting motion of the vehicle seat. Also provided is a vehicle, as well as a method for manufacturing a vehicle seat.

### CROSS-REFERENCE TO RELATED APPLICATION

This application claims priority to German Patent Application No. 10 2011 120 533.4, filed Dec. 8, 2011, which is incorporated herein by reference in its entirety.

### TECHNICAL FIELD

The present disclosure pertains to a vehicle seat for a vehicle, and also pertains to a method for manufacturing a vehicle seat.

### BACKGROUND

Pivoting and/or sliding vehicle seats are generally known. When pivoting a vehicle seat, it is initially folded up and then positioned upright in order to make it easier for a passenger to gain access to a row of seats behind this vehicle seat. When sliding a vehicle seat, it is longitudinally displaced relative to a vehicle floor. Vehicle seats of this type are constructed differently depending on whether they are designed in a pivoting, sliding or pivoting and sliding fashion. For example, a pivoting and sliding vehicle seat of a second row of seats in a vehicle with seven seats differs from a sliding vehicle seat of the second row of seats in a vehicle with five seats. This means that the vehicle seats cannot be flexibly utilized. The proportion of identically constructed components of the vehicle seats is small such that the production effort and the production costs are high.

Therefore, it may be desirable to develop a vehicle seat that can be flexibly utilized without significant structural alterations. It may also be desirable to develop a vehicle and a method for manufacturing such a vehicle seat. In addition, other objects, desirable features and characteristics will become apparent from the subsequent summary and detailed description, and the appended claims, taken in conjunction with the accompanying drawings and this background.

### SUMMARY

According to various exemplary embodiments, the present disclosure provides a vehicle seat for a vehicle that comprises a seat structure and at least one seat rail arrangement with at least one adapter device between the seat structure and the at least one seat rail arrangement in order to ensure a sliding motion and/or pivoting motion of the vehicle seat. It is advantageous that such a vehicle seat can be flexibly utilized without significant structural alterations. In this case, it is possible to pivot and/or slide the vehicle seat. In one exemplary embodiment, the vehicle seat is suitable, in one example, for a so-called easy-entry system. In another exemplary embodiment, the vehicle seat can be utilized without such an easy-entry system. The vehicle seat is realized in the form of a sliding vehicle seat in one exemplary embodiment. In another exemplary embodiment, the vehicle seat is realized in the form of a pivoting and sliding vehicle seat.

The vehicle seat comprises the seat structure. The seat structure of the vehicle seat is generally realized in the form of a multipiece seat structure. In one exemplary embodiment, the seat structure comprises a pivoting backrest and a seat part. The backrest is coupled to the seat part in one exemplary embodiment. In this case, a pivoting motion of the backrest is transmitted, for example, to the seat part such that the seat part is rotated. The seat part is advantageously rotated about a stationary pivot bearing in a rear region, wherein a front region of the seat part is lowered. The pivot bearing of the seat part and a pivot bearing of the backrest, about which the pivoting motion takes place, are generally realized stationarily on the seat structure and spaced apart from one another.

The vehicle seat furthermore comprises at least one seat rail arrangement. The seat rail arrangement is generally mounted on a motor vehicle structure, for example, in a stationary fashion. The at least one seat rail arrangement advantageously makes it possible to slide the vehicle seat back and forth relative to a vehicle floor or a motor vehicle structure, generally forward and backward in a longitudinal direction, i.e., in the viewing direction of a person seated in the motor vehicle or in the longitudinal vehicle direction. For this purpose, the at least one seat rail arrangement is connected to the vehicle floor on the one hand and to the seat structure on the other hand. For example, the seat rail arrangement features a rail part mounted on the vehicle and a rail part mounted on the seat that can be displaced relative to one another. Only one seat rail arrangement is provided in one exemplary embodiment. In other exemplary embodiments, more than one seat rail arrangement such as, for example, two, three or four seat rail arrangements are provided. Generally, two seat rail arrangements are provided. The seat rail arrangements are advantageously arranged on both sides of the seat structure in order to allow a uniform and stable sliding motion of the vehicle seat. The seat rail arrangement is realized in the form of a displacement device in one exemplary embodiment. The displacement device comprises at least one mounting unit for a locking unit for locking the vehicle seat on the displacement device, wherein the mounting unit is integrated into the displacement device such that the mounting unit at least does not laterally protrude over the displacement device.

The vehicle seat comprises at least one adapter device. Only one adapter device is provided in one exemplary embodiment. In other exemplary embodiments, more than one adapter device such as, for example, two, three or four adapter devices are provided. In one example, two adapter devices are provided. One adapter device is advantageously provided per seat rail arrangement. The adapter devices of the vehicle seat are advantageously realized in a uniform fashion. For example, several adapter devices of adjacent vehicle seats are coupled to one another. It is advantageous to respectively arrange the adapter devices between the seat structure and the seat rail arrangements. Accordingly, the adapter devices are advantageously arranged on both sides of the vehicle seat. In one exemplary embodiment, the adapter device comprises a one-piece adapter device. A multipiece adapter device that comprises, for example, two pieces, generally three or four pieces, is provided in other exemplary embodiments.

The adapter devices advantageously make it possible to slide and to pivot a vehicle seat. Depending on the design of the adapter devices, the vehicle seat can be flexibly utilized without further structural alterations. Consequently, a sliding vehicle seat merely differs from a pivoting and sliding vehicle seat with respect to the design of the adapter devices while the remaining components of the vehicle seats are generally realized identically. The vehicle seats therefore can be flexibly utilized with a minimal alteration of their design, namely a change of the adapter devices. The vehicle seat is advantageously realized in the form of a sliding vehicle seat by means of the adapter devices. A modification of the adapter devices advantageously also makes it possible to pivot the vehicle seat.

According to one exemplary embodiment, it is proposed that the at least one adapter device features a rail unit on the side of the seat rails in order to ensure a displacement of the seat structure relative to the at least one seat rail arrangement. The rail unit is generally realized in the form of a one-piece rail unit. In other exemplary embodiments, the rail unit is realized in the form of a multipiece rail unit. The rail unit is advantageously connected to the seat rail arrangement. In this respect, the rail unit generally is movably connected to the seat rail arrangement, for example, in a displaceable and/or sliding fashion. In one exemplary embodiment, the rail unit is connected to the rail part of the seat rail arrangement that is mounted on the seat, wherein a sliding motion of the vehicle seat causes the rail part mounted on the seat to be displaced relative to the rail part mounted on the vehicle together with the rail unit and the vehicle seat.

According to another exemplary embodiment, it is proposed that the at least one adapter device features a lever unit on the side of the seat structure. The lever unit is generally realized in the form of a one-piece lever unit. In other exemplary embodiments, the lever unit is realized in the form of a multipiece lever unit. The seat structure is advantageously connected to the lever unit. In one exemplary embodiment, the seat structure is rigidly connected to the lever unit, i.e., in an immovable fashion. Depending on the design of the lever unit and/or the rail unit, the adapter device ensures a sliding motion and/or pivoting motion of the vehicle seat.

In one exemplary embodiment, it is accordingly proposed that the rail unit and the lever unit are at least partially integrated and/or realized separately of one another. In one exemplary embodiment, the rail unit and the lever unit are respectively integrated or realized in one piece. A one-piece adapter device is provided in this exemplary embodiment. In this case, the one-piece adapter device ensures a sliding motion of the seat structure on the seat rail arrangements. The rail unit with the integrated lever unit forms a mounting of the vehicle seat on the movable or displaceable seat rail arrangements. Consequently, a vehicle seat with a thusly designed adapter device is realized in the form of a sliding vehicle seat. During a sliding motion of the vehicle seat, the adapter device generally is displaced relative to the rail part mounted on the vehicle together with the rail part mounted on the seat. As an alternative to a one-piece design, the rail unit and the lever unit may also be realized separately and movably connected to one another, i.e., fixed on one another, for example, by means of welding, a screw connection and/or bonding.

Another design of the adapter device, i.e., a slightly altered construction of the adapter device, also makes it possible to realize the vehicle seat in the form of a pivoting vehicle seat. In this exemplary embodiment, the rail unit and the lever unit are respectively realized separately or in two pieces. A multipiece adapter device, i.e., an adapter device comprising at least two pieces, is provided in this exemplary embodiment. The rail unit and the lever unit generally are movably connected to one another, particularly in a pivoting fashion. In one exemplary embodiment, the rail unit and the lever unit are mounted in a front region that respectively faces away from the backrest of the seat structure and is oriented in the viewing direction of a seated person. The mounting is realized, for example, in the form of a pivot joint and/or hinge in order to allow a pivoting motion of the rail unit and the lever unit. When pivoting the vehicle seat, the rail unit advantageously remains stationary on the seat rail arrangement while the seat structure with the lever unit is pivoted.

In one exemplary embodiment, it is accordingly proposed that the at least one adapter device features a bearing unit in order to ensure a pivoting motion of the vehicle seat. The seat structure with the lever unit is advantageously pivoted against the rail unit on the seat rail arrangement. In this exemplary embodiment, the rail unit and the lever unit are realized separately of one another. The bearing unit is realized, for example, in the form of a one-piece bearing unit. In other exemplary embodiments, the bearing unit is realized in the form of a multipiece bearing unit. In this case, the bearing unit is realized between the rail unit on the side of the seat rails and the lever unit on the side of the seat structure in order to realize these units such that they can be pivoted relative to one another. The bearing unit is generally arranged on the front end of the rail unit and lever unit or the seat rail arrangement, respectively. The bearing unit comprises, for example, a pivot bearing in the form of a pivot joint and/or a hinge.

According to another exemplary embodiment, it is proposed that the at least one adapter device features a locking unit in order to release and/or block a pivoting motion of the vehicle seat. The locking unit advantageously locks or blocks the pivoting function of the adapter device. When the pivoting function is locked, for example, it is possible to slide the vehicle seat, but a pivoting motion of the vehicle seat is prevented. In this case, pivoting of the rail unit and the lever unit is prevented. In the released state, the rail unit and the lever unit can be folded or pivoted relative to one another. In one exemplary embodiment, the locking process takes place, in one example, automatically during the operation of the vehicle. For example, the locking unit is realized electrically, electronically, mechatronically and/or mechanically. According to one exemplary embodiment, it is proposed that the locking unit is integrated into the bearing unit. According to an exemplary embodiment, it is proposed that the locking unit is realized separately of the bearing unit. The locking unit generally is arranged on the rail unit or lever unit at a distance from the bearing unit. The locking unit is realized, for example, in the form of a one-piece locking unit. In other exemplary embodiments, the locking unit is realized in the form of a multipiece locking unit. The locking unit is realized, for example, in the form of a shackle lock with a shackle part and a lock part. In this case, the shackle part prevents the rail unit and the lever unit from being pivoted apart in that it engages into the rail unit and the lever unit with its ends in a tong-like fashion and thusly fixes said units on the one another.

The locking unit generally forms part of the easy-entry system. The locking unit is generally integrated into the lever part and/or the rail part, particularly integrated such that it does not protrude over the respective part. In this way, a symmetrical design of the adapter devices can be realized such that no left-sided and right-sided variations are required.

In a one-piece design, i.e., with integrated rail unit and lever unit, the adapter device ensures a sliding motion of the vehicle seat. In contrast, a multipiece adapter device, generally a four-piece variation with separate rail unit and lever unit, as well as bearing unit and locking unit, also makes it possible to pivot the vehicle seat. Consequently, only the design of the adapter device needs to be adapted in order to ensure the different functions of the vehicle seat and to design the vehicle seat in a flexible fashion. The remaining components of the vehicle seat are not affected by this and advantageously can be realized identically. Consequently, the production effort for the manufacture of different vehicle seats is minimized

In a vehicle that comprises at least one row of seats with at least one seat, the present disclosure furthermore incorporates the technical feature of realizing the at least one seat in the form of an above-described vehicle seat. The vehicle comprises, for example, a limousine, a station wagon, a van, a bus, a minibus, a sport utility vehicle or the like. The vehicle generally features a first front row of seats. According to one exemplary embodiment, the vehicle features at least one other row of seats, for example, a second and/or third row of seats. The seats of the second and/or third row of seats are advantageously realized in the form of above-described vehicle seats with adapter devices. In this case, the vehicle seats advantageously differ only with respect to their adapter devices. The vehicle seats in a second of three rows of seats are advantageously realized in the form of pivoting and sliding vehicle seats in order to make it easier to access the third row of seats. The adapter devices are accordingly realized in the form of multipiece adapter devices. The vehicle seats in a rear row of two rows of seats, in contrast, are advantageously realized in the form of sliding vehicle seats. In this case, a pivoting function of the vehicle seats can be advantageously eliminated.

According to one exemplary embodiment, the pivoting function of the vehicle seat features a coupling between a pivoting motion of the backrest and a rotational motion of the seat part. The pivoting of the backrest advantageously causes a rotation of the seat part about a stationary rotational axis in a rear region of the seat part. The pivoting of the vehicle seat then takes place while the backrest is folded on the seat part.

In a method for manufacturing a vehicle seat for a vehicle that comprises a seat structure and at least one seat rail arrangement, in which the seat structure is connected to the seat rail arrangement, the present disclosure also incorporates the technical feature of producing said connection by connecting the seat structure and the seat rail arrangement to a common adapter device in order to manufacture vehicle seats that differ with respect to their function with an identical construction except for the adapter device. The seat structure and the seat rail arrangement are advantageously connected by means of the adapter device. In this case, vehicle seats with an identical construction, i.e., with the same seat structure and seat rail arrangement, are advantageously connected with different adapter devices. Accordingly, the vehicle seats differ with respect to the design of the adapter device. Depending on the design of the adapter device, the vehicle seats are realized in the form of sliding vehicle seats or sliding and pivoting vehicle seats. Consequently, this makes it possible to increase the flexibility, as well as to reduce the material input and the costs, in the manufacture of the vehicle seats.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 shows a detail of a perspective view of a vehicle seat with an adapter device according to an exemplary embodiment,

FIG. 2 shows a detail of FIG. 1 in the form of a different perspective view,

FIG. 3 shows a detail of FIG. 1 in the form of a rear view,

FIG. 4 shows a detail of a perspective view of the vehicle seat according to FIG. 1 in a displaced state,

FIG. 5 shows a detail of a perspective view of a vehicle seat with an adapter device according to another exemplary embodiment,

FIG. 6 shows a detail of FIG. 5 in the form of a different perspective view,

FIG. 7 shows a detail of FIG. 5 in the form of a rear view,

FIG. 8 shows a detail of a perspective view of the vehicle seat according to FIG. 5 in a pivoted state,

FIG. 9 shows a perspective view of a row of seats that features several vehicle seats with the adapter device according to FIG. 1, and

FIG. 10 shows a perspective view of a row of seats that features several vehicle seats with the adapter device according to FIG. 5.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

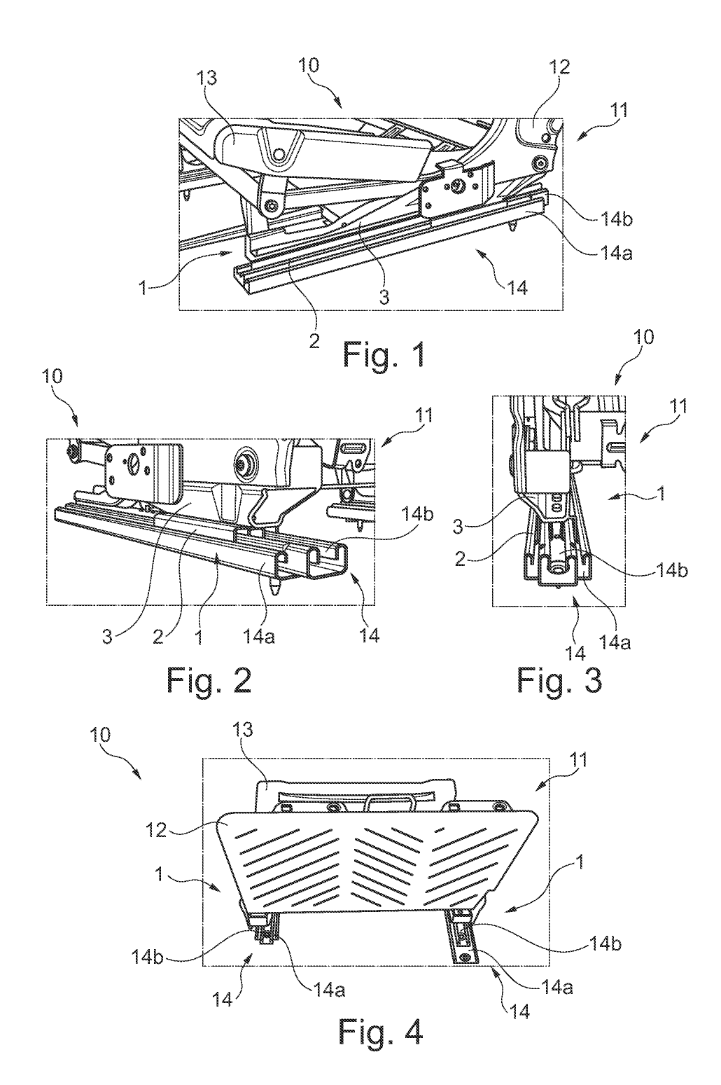

FIG. 1 shows a detail of a perspective view of a vehicle seat 10 with an adapter device 1 according to an exemplary embodiment. The vehicle seat 10 comprises a seat structure 11. The seat structure 11 comprises a backrest 12 and a seat part 13. In this case, the backrest 12 can be pivoted relative to and/or is coupled to the seat part 13. The vehicle seat 10 furthermore comprises two seat rail arrangements 14. The seat rail arrangements 14 are arranged on the seat part 13 on both sides of the vehicle seat 10, namely parallel to one another along a longitudinal vehicle direction or a longitudinal extent, and laterally spaced apart from one another. The rail arrangements 14 make it possible to slide the vehicle seat 10 in the longitudinal direction relative to a (not-shown) vehicle floor. The rail arrangements 14 respectively feature a rail part 14a mounted on the vehicle and a rail part 14b mounted on the seat. The rail part 14a mounted on the vehicle is stationarily fixed on the vehicle floor. The rail part 14b mounted on the seat is fixed on an adapter device 1. The rail parts 14a and 14b are realized such that they can slide relative to one another. A detailed description of the rail parts 14a and 14b or the seat rail arrangement 14 is not provided because these components are generally known in the art.

According to one exemplary embodiment of the present disclosure, an adapter device 1 is respectively provided between the seat structure 11 and the seat rail arrangements 14 in order to ensure a sliding motion and/or a pivoting motion of the vehicle seat 10. In FIG. 1, the adapter device 1 is only illustrated on the side of the vehicle seat 10 that faces the observer. The adapter device 1 is arranged between the seat structure 11 or, in more precise terms, the seat part 13 and the seat rail arrangement 14. In this exemplary embodiment, the adapter device 1 is realized in the form of a one-piece adapter device. The adapter device 1 features a rail unit 2 on the side of the seat rails with an integrated lever unit 3 on the side of the seat structure. The rail unit 2 is fixed on the rail part 14b of the seat rail arrangement 14 that is mounted on the seat. During a sliding motion of the vehicle seat 10, the rail part 14b mounted on the seat moves relative to the rail part 14a mounted on the vehicle together with the adapter device 1 mounted thereon and the seat structure 11.

FIGS. 2 and 3 respectively show different views of a detail of FIG. 1. FIG. 2 shows a different perspective view and FIG. 3 shows a rear view. The vehicle seat 10 with the seat structure 11, the seat rail arrangement 14 and the adapter device 1 corresponds to the exemplary embodiment according to FIG. 1. Consequently, a detailed description of already described components is not provided. Identical components are identified by the same reference symbols. FIGS. 2 and 3 show detailed illustrations of the adapter device 1 on the rail part 14b mounted on the seat, as well as the rail part 14a mounted on the vehicle. The rail unit 2 encompasses the rail part 14b mounted on the seat on both sides similar to a shackle or a clamp in order to thusly achieve a stable mounting of the seat structure 11. During a sliding motion of the vehicle seat 10, the rail parts 14a and 14b slide relative to one another. The adapter device 1 with the seat structure 11 moves with the rail part 14b mounted on the seat. FIGS. 2 and 3 furthermore show the C-shaped profile of the rail parts 14a and 14b with undercut areas.

FIG. 4 shows a detail of a perspective view of the vehicle seat 10 according to FIG. 1 in a displaced state. The vehicle seat 10 is illustrated in the form of a rear view above the backrest 12. In this case, the vehicle seat 10 with its components corresponds to the exemplary embodiment according to FIG. 1. Consequently, a detailed description of already described components is not provided. Identical components are identified by the same reference symbols. In FIG. 4, the vehicle seat 10 is displaced forward, i.e., in the viewing direction of a person sitting on the seat or in the direction of the vehicle front, respectively, on the seat rail arrangement 14. The adapter device 1 with the seat structure 11 mounted thereon is in this case displaced relative to the stationary rail part 14a mounted on the vehicle on the rail part 14b mounted on the seat.

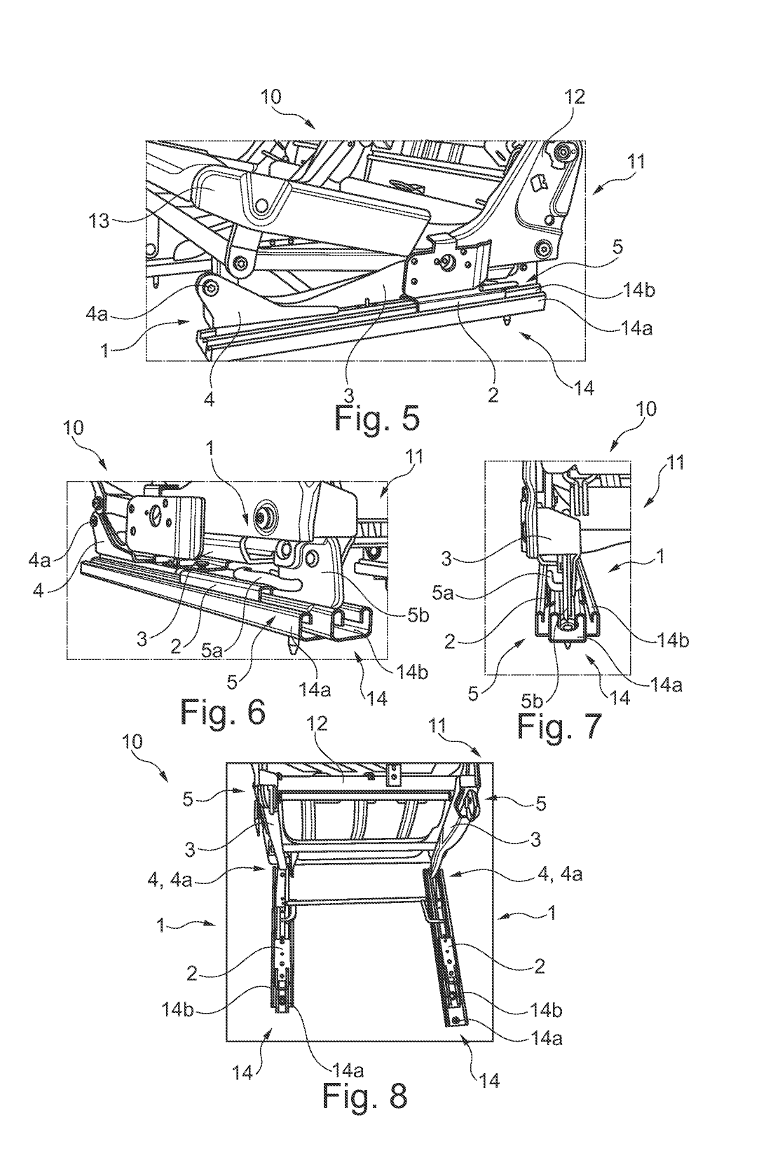

FIG. 5 shows a detail of a perspective view of a vehicle seat 10 with an adapter device 10 according to another exemplary embodiment. With respect to their design and function, the seat structure 11 and the seat rail arrangement 14 correspond to the exemplary embodiment according to FIG. 1. Consequently, a detailed description of already described components is not provided. Identical components are identified by the same reference symbols. The embodiments according to FIGS. 1 and 4 differ with respect to the adapter device 1.

In FIG. 5, the adapter device 1 is realized in the form of a multipiece adapter device in order to also make it possible to pivot the vehicle seat 10. In this case, the rail unit 2 and the lever unit 3 are realized in the form of separate components that are movably connected to one another. The adapter device 1 furthermore features a bearing unit 4. The bearing unit 4 is arranged in a front end of the seat rail arrangement 14. According to this exemplary embodiment, the bearing unit 4 is realized in the form of a hinge. In this way, the bearing unit 4 makes it possible to pivot the lever unit 3 relative to the rail unit 2 about a pivoting axis 4a. During the pivoting process, the lever unit 3 is pivoted upward together with the seat structure 11 mounted thereon. The rail unit 2 remains fixed on the seat rail arrangement 14 (see FIG. 8).

The adapter device 1 furthermore features a locking unit 5. The locking unit 5 makes it possible to block the pivoting motion. In this respect, the locking unit 5 prevents the rail unit 2 and the lever unit 3 from being pivoted apart. In this exemplary embodiment, the locking unit 5 is arranged distant from the bearing unit 4 on an opposite end of the seat rail arrangement 14. The locking unit 5 is realized in the form of a two-piece locking unit with a shackle part 5a and a lock part 5b (see FIGS. 6 and 7). In FIG. 5, the locking unit 5 is illustrated in an unlocked state.

FIGS. 6 and 7 respectively show different views of a detail of FIG. 5. FIG. 6 shows a different perspective view and FIG. 7 shows a rear view. The vehicle seat 10 with the seat structure 11, the seat rail arrangement 14 and the adapter device 1 corresponds to the exemplary embodiment according to FIG. 5. Consequently, a detailed description of already described components is not provided. Identical components are identified by the same reference symbols. FIGS. 6 and 7 show detailed illustrations of the adapter device 1 with the bearing unit 4 and the locking unit 5. The shackle part 5a and the lock part 5b of the locking unit 5 are respectively arranged centrally on the rail unit 2 and the lever unit 3 in order to ensure a uniform and reliable locking function.

FIG. 8 shows a detail of a perspective view of the vehicle seat according to FIG. 5 in a folded or pivoted state. The vehicle seat 10 is illustrated in the form of a rear view above the backrest 12. In this case, the vehicle seat 10 with its components corresponds to the exemplary embodiment according to FIG. 5. Consequently a detailed description of already described components is not provided. Identical components are identified by the same reference symbols. In FIG. 8, the vehicle seat 10 is pivoted up and forward about the pivoting axis 4a by means of the bearing unit 4 on the front end of the seat rail arrangement 14. In this case, the rail unit 2 remains stationarily on the seat rail arrangement 14 while the seat structure 11 connected to the lever unit 3 is pivoted about the pivoting axis 4a. The adapter device 1 makes it possible to realize this pivoting motion in addition to the displacement of the seat structure 11 on the rail parts 14a and 14b.

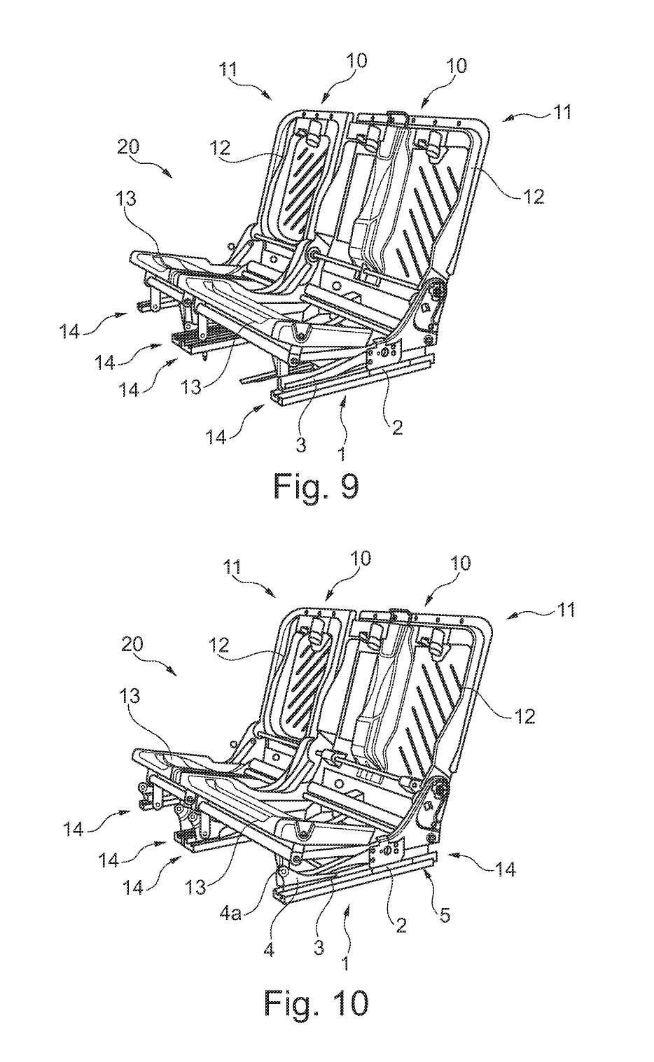

FIG. 9 shows a perspective view of a row of seats 20 that features several vehicle seats 10 with the adapter device 1 according to FIG. 1. The row of seats 20 is realized in the form of the second or rear row of seats 20, for example, in a vehicle with two rows of seats 20. In this case, the row of seats 20 features two vehicle seats 10 that are connected to one another, wherein the vehicle seats 10 in the row of seats 20 are divided in accordance with a 60:40 ratio. Both vehicle seats 10 respectively feature an adapter device 1 on both of their sides. Consequently, a total of four identically designed adapter devices 1 are provided, wherein only the adapter device 1 that is arranged on the side of the row of seats 20 facing the observer is illustrated in this figure. The vehicle seats 10 and the adapter devices 1 correspond to the exemplary embodiment according to FIG. 1. Consequently, a detailed description of already described components is not provided. Identical components are identified by the same reference symbols. Analogous to the exemplary embodiment of the one-piece adapter devices 1 with integrated rail unit 2 and lever unit 3, it is possible to slide the vehicle seats 10 individually or jointly in the longitudinal direction on the seat rail arrangement 14.

FIG. 10 shows a perspective view of a row of seats 20 that features several vehicle seats 10 with the adapter device 1 according to FIG. 5. The row of seats 20 is realized in the form of a second or central row of seats 20, for example, in a vehicle with three rows of seats. In this case, the row of seats 20 features two vehicle seats 10 that are connected to one another. The row of seats 20 and the vehicle seats 10 illustrated in FIG. 10 substantially corresponds to the exemplary embodiment according to FIG. 9. Consequently, a detailed description of already described components is not provided. Identical components are identified by the same reference symbols. The exemplary embodiment of the vehicle seats 10 illustrated in FIG. 10 merely differs from the vehicle seats 10 according to FIG. 9 with respect to the design of the adapter devices 1 that corresponds to the exemplary embodiment according to FIG. 5 in this case. The adapter devices 1 accordingly are realized in the form of multipiece adapter devices with separate rail unit 2 and lever unit 3, as well as bearing unit 4 and locking unit 5. The vehicle seats 10 are realized such that they can be individually or jointly pivoted on the seat rail arrangement 14.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. A vehicle seat for a vehicle, comprising:
a seat structure; and
at least one seat rail arrangement,
wherein at least one adapter device is provided between the seat structure and the at least one seat rail arrangement in order to ensure at least one of a sliding motion and a pivoting motion of the vehicle seat.

2. The vehicle seat according to claim 1, wherein the at least one adapter device features a rail unit on a side of seat rails in order to ensure a sliding motion of the seat structure relative to the at least one seat rail arrangement.

3. The vehicle seat according to claim 2, wherein the at least one adapter device features a lever unit on a side of the seat structure.

4. The vehicle seat according to claim 3, wherein the rail unit and the lever unit are at least partially integrated.

5. The vehicle seat according to claim 3, wherein the rail unit and the lever unit are realized separately of one another.

6. The vehicle seat according to claim 3, wherein the at least one adapter device features a bearing unit in order to ensure a pivoting motion of the vehicle seat.

7. The vehicle seat according to claim 6, wherein the at least one adapter device features a locking unit in order to at least one of release and block a pivoting motion of the vehicle seat.

8. A vehicle, comprising:
at least one row of seats with at least one seat, the at least one seat including a seat structure, at least one seat rail arrangement, and at least one adapter device,
wherein the at least one adapter device is provided between the seat structure and the at least one seat rail arrangement in order to ensure at least one of a sliding motion and a pivoting motion of the at least one seat.

9. The vehicle according to claim 8, wherein the at least one adapter device features a rail unit on a side of seat rails in order to ensure a sliding motion of the seat structure relative to the at least one seat rail arrangement.

10. The vehicle according to claim 9, wherein the at least one adapter device features a lever unit on a side of the seat structure.

11. The vehicle according to claim 10, wherein the at least one adapter device features a bearing unit in order to ensure a pivoting motion of the at least one seat.

12. The vehicle according to claim 11, wherein the at least one adapter device features a locking unit in order to at least one of release and block a pivoting motion of the at least one seat.

13. A method for manufacturing a vehicle seat for a vehicle that comprises a seat structure and at least one seat rail arrangement, with the seat structure being connected to the at least one seat rail arrangement, comprising:
connecting the seat structure and the at least one seat rail arrangement to a common adapter device in order to manufacture vehicle seats that differ with respect to their function with an identical construction except for the adapter device.
